(19) United States
(12) Patent Application Publication
(10) Pub. No.: US 2025/0165631 A1
(43) Pub. Date: May 22, 2025

(54) CROSS-DOMAIN TRIGGERS FOR EXECUTING DATA OPERATIONS ACROSS DATA DOMAINS

(71) Applicant: Zendesk, Inc., San Francisco, CA (US)

(72) Inventors: Sanjeev Kumar Biswas, Ashfield (AU); Jakub Konik, Kraków (PL); Prakruti Hindia, Singapore (SG)

(73) Assignee: Zendesk, Inc., San Francisco, CA (US)

(21) Appl. No.: 18/512,905

(22) Filed: Nov. 17, 2023

(51) Int. Cl. G06F 21/62

(52) U.S. Cl. CPC G06F 21/6218

(57) ABSTRACT

A system and methods are provided for executing data operations across data domain boundaries without sharing a domain's data outside of the domain. A coordinator computer, module, or mechanism receives a trigger (or other automated process) and logically divides it into multiple fragments, each fragment corresponding to one domain and comprising data operations that require access to the corresponding domain's data. When the trigger is activated, the coordinator calls or invokes trigger engines within each domain to execute, in order, each fragments' data operations and receive an indication as to whether they completed successfully. A following fragment and its data operations may not be invoked unless and until the preceding fragments operations succeeded. If all fragments' data operations along a path from a root of the trigger to an end of the trigger complete successfully, one or more associated actions are executed.

### BACKGROUND

This disclosure relates to the fields of computer systems and data processing. More particularly, a system and methods are provided for enabling cross-domain triggers that, when activated, access or modify data across data domains.

Computer systems and environments that support online systems sometimes offer means for recognizing a particular data event, pattern, or request and automatically initiating specified actions upon recognition of the event. For example, triggers may be defined to examine a given set of data and, upon identifying predetermined values for one or more fields of the data, may modify the set of data and/or perform some other action.

However, triggers are usually limited in scope such that they may only access data within a particular data domain. For example, triggers enabled for a customer-support application or service may be limited to accessing data related to customer-support tickets. Similarly, triggers enabled for a chat function or service may be limited to accessing data regarding messages and users, respectively, and triggers enabled for ecommerce applications may only be able to access data related to ecommerce transactions.

Therefore, a user or organization that uses or accesses multiple applications or services having separate data domains (e.g., for customer-support, chat, ecommerce) is unable to configure an automated process for examining and/or modifying data in more than one of those domains.

### SUMMARY

In some embodiments, systems and methods are provided for configuring and executing cross-domain triggers to access (e.g., read and/or write) data residing in different data domains, while preventing data spillage between domains and preventing unauthorized data access. Each domain may host any number of services or applications, and maintain data used by and for the services.

In illustrative embodiments, a cross-domain trigger is obtained that comprises a series of data operations involving data residing, hosted, and/or maintained in multiple different domains. Each data operation may, for example, compare a current value of a parameter or field of a particular domain's data to a target value or set of values using a particular operator (e.g., less than, equal to, not equal to, greater than or equal to).

A cross-domain trigger is partitioned into multiple fragments, with each fragment corresponding to one domain and comprising those data operations of the trigger that require access to data in the corresponding domain. If the trigger includes multiple paths, it may be decomposed into a collection of paths that may involve the same or different fragments. Data operations of different paths may or may not overlap.

Some or all paths of the trigger are then traversed to execute or evaluate each fragment and each fragment's data operations. Processing may stop when a valid path is found, from a root of the cross-domain trigger to an end, in which all data operations succeed, or when all paths have been examined without finding a valid path. During traversal of a path, processing may be aborted when a data operation or fragment fails. When a valid or successful path is found, one or more actions associated with the cross-domain trigger are executed.

### DESCRIPTION OF THE FIGURES

FIG. 1A depicts illustrative triggers, according to some embodiments.

FIG. 1B depicts deconstruction of a trigger into multiple separate paths, according to some embodiments.

FIG. 2 is a block diagram of an illustrative computing environment in which triggers may operate across data domain boundaries, according to some embodiments.

FIG. 3 depicts an illustrative cross-domain trigger, according to some embodiments.

FIG. 4 is a flow chart illustrating a method of using a cross-domain trigger, according to some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, methods and systems are provided for creating and/or executing automated processes, such as triggers, that, instead of being limited in scope to a single data domain (e.g., the data domain or environment associated with a particular product or service), can operate across data domain boundaries. In other words, a developer or user of a particular service can configure a trigger or other process that, when executed, is able to examine and/or modify data values in data domains foreign to the service.

In these embodiments, multiple products and/or services offered by an organization operate or execute in separate data domains, and customers, users, developers, operators, and/or other entities may create triggers for examining and/or modifying data associated with a transaction (e.g., a purchase), with a customer-support issue (e.g., a trouble ticket), with usage of a product or service (e.g., a guide), etc. Heretofore, each trigger was limited to operating within one data domain, meaning that it could not look at or affect data associated with other products and services. In addition, the different data domains may employ different data schemas, differently formatted triggers, different business rules, etc.

As used herein, “triggers” (including automations and/or other processes) comprise conditions linked by Boolean operators (e.g., AND, OR) and one or more actions to be performed when the trigger is successfully executed or evaluated, and may be represented with a directed graph in which each node comprises either a condition, an action, or an event (e.g., an event that invokes the trigger or causes the trigger to be applied). Each condition compares the current value of a parameter (e.g., a variable, a field within a data set or record) to one or more target values (e.g., a single value, a range or set of values) using an appropriate operator (e.g., equal to, greater than, less than or equal to, not equal to). A condition is considered satisfied, successful, or True when the comparison is True. When all conditions along a path of a trigger, from a root node (e.g., a node comprising a data event or a first condition) to an end node associated with the trigger's action(s), are True, the trigger is considered satisfied and the associated action(s) are executed.

A “single-domain trigger” comprises conditions that only involve parameters within one domain's data. A “cross-domain trigger” comprises conditions that involve parameters stored in two or more domains' data.

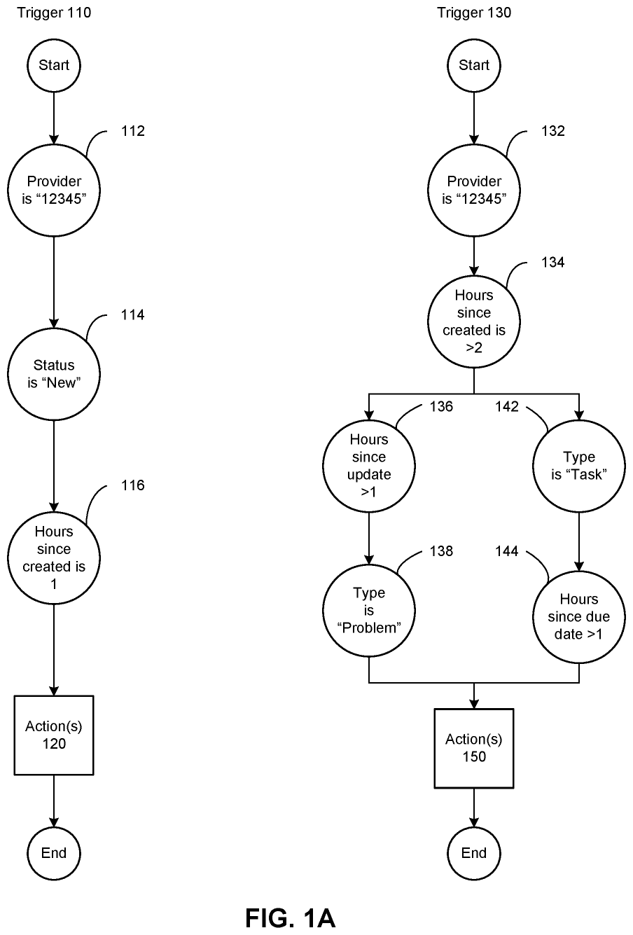

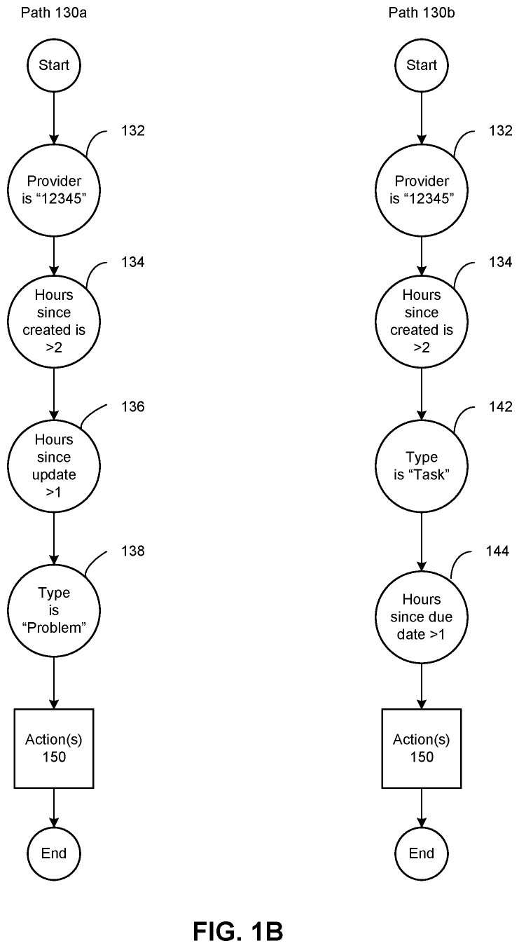

FIG. 1A illustrates triggers according to some embodiments. In these embodiments, trigger 110 is a simple single-domain trigger that may be executed against a set of data or a data record comprising a customer support ticket. Node/condition 112 is the root node and the starting point for the trigger, and yields a determination as to whether the ticket is associated with a provider having the identifier 12345.

Next, condition 114 determines whether the ticket status is “New,” and condition 116 determines whether one hour has passed since the ticket was created (i.e., whether the ticket is at least one hour old). End node 104 represents the data and/or other computer operation(s) that will be initiated upon completion or satisfaction of the trigger (e.g., after conditions 112, 114, 116 are satisfied or true.

In these embodiments, an action usually involves altering in some way the ticket upon which the trigger is executing, by modifying the value or values of one or more ticket fields, for example. This may be done at least in part to nullify one of the conditions that caused action(s) 120 to be implemented, thereby preventing a processing loop. For example, an action 120 of trigger 110 may change the ticket status to a value other than New (e.g., “Pending”). However, an action may also entail other activity, such as initiation of a communication (e.g., to an end user or a customer support agent), an increase in the ticket's priority, etc.

Trigger 130 of FIG. 1A is more complex than trigger 110 due to the inclusion of an OR operator, but may still be a single-domain trigger. First, condition 132 is applied to determine whether the provider associated with a customer-support ticket upon which the trigger is executing is 12345. Then, condition 134 is applied to determine whether the ticket is at least two hours old. At this point, the OR operator allows either (or both) of two branches or paths to be satisfied and (assuming conditions 132, 134 are true) cause action(s) 150 to be performed.

Condition 136 tests whether the ticket was last updated more than an hour in the past and condition 138 determines whether the ticket type is “Problem” (e.g., whether a ‘type’ field of the ticket has the value “Problem”). Condition 142 determines whether the ticket type is “Task” and condition 144 is applied to determine whether a due date of the ticket (e.g., when it was supposed to be completed or resolved) passed more than an hour ago. As described above, action(s) 150 may include any type and number of operations that change the ticket and/or involve other activity.

FIG. 1B depicts deconstruction of a trigger into multiple separate paths, according to some embodiments. In these embodiments, trigger 130 is deconstructed into paths 130a and 130b, wherein each path comprises a different branch of the OR operation.

Thus, path 130a comprises all conditions before the OR (i.e., conditions 132, 134) and all conditions that are reached through a first branch (i.e., conditions 136, 138). Path 130b comprises the conditions before the OR and all conditions reached through the second branch (i.e., conditions 142, 144). The number of paths into which a trigger can be deconstructed depend upon the number of OR operators in the trigger and the number of branches created by each OR.

As discussed further below, in addition to (or instead of) a trigger being divided into distinct paths (e.g., when it contains an OR operator), a trigger may be divided into fragments or segments based on some other criteria. For example, in embodiments disclosed herein, a cross-domain trigger can be divided into multiple fragments, wherein each fragment corresponds to a different domain and contains conditions and/or data operators related to only that domain's data. In different implementations, a trigger may first be divided into fragments and then decomposed into paths or it may first be decomposed into paths and then the paths may be divided into fragments.

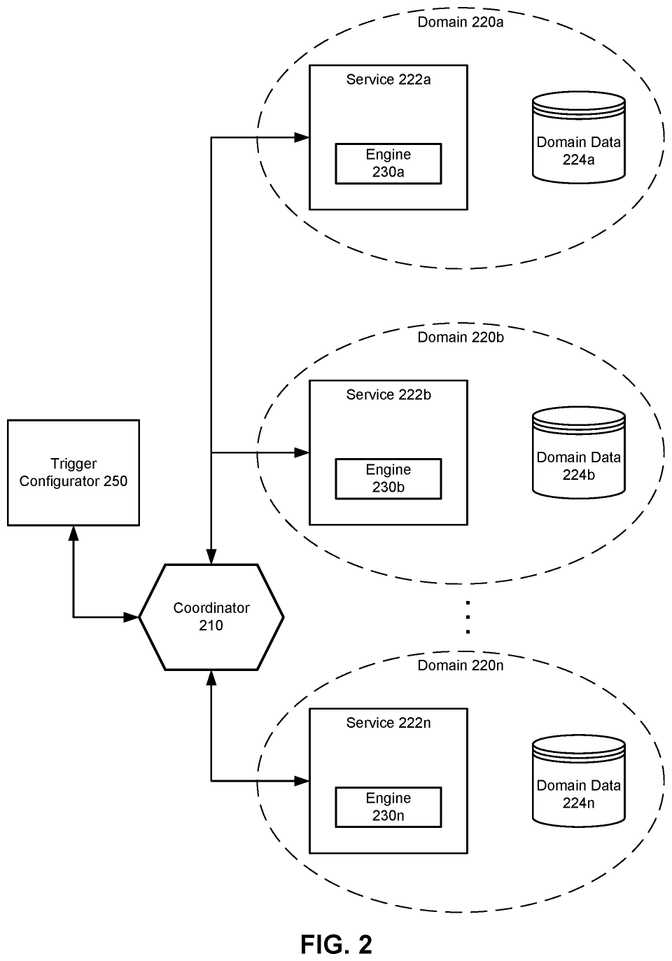

FIG. 2 is a block diagram of an illustrative computing environment in which triggers may operate across data domain boundaries, according to some embodiments. In these embodiments, a developer, operator, or other user located within one domain, or an administrator associated with multiple domains, may configure a cross-domain trigger that accesses data within any number of separate domains.

The environment of FIG. 2 features multiple domains 220 (i.e., domains 220a-220n), which may be logically separated by network addresses (e.g., by defining different subnetworks), may enforce different access control lists, or use some other mechanism to prevent external users (users of other domains) from accessing data within the domain, except as provided herein. Each domain 220 hosts at least one service 222 (i.e., services 222a-222n), which may execute on any number and type of computer servers, clusters, and/or other computing platforms. Moreover, each domain 220 maintains its own domain data 224 (i.e., domain data 224a-224n) for its local service(s), which may include any number of databases or other repositories, and which may be partitioned, sharded, or otherwise distributed within the domain.

Services 222 are enhanced with trigger engines 230 (i.e., engines 230a-230n) to enable operation of cross-domain (and single-domain) triggers. More specifically, engines 230 implement common rules for evaluating (e.g., executing) triggers, and enforce common data schema across all data domains. Each instance of engine 230, however, may be customized for the service 222 and domain 220 in which it operates. Thus, trigger engine 230a and trigger engine 230b may be configured with different trigger rules that limit them to evaluating conditions that involve their local data 224 and/or changing values among local data 224.

In some embodiments in which the services continually generate and/or receive events associated with user activity (e.g., via a publish-subscribe system), the services' trigger engines 230 may automatically evaluate one or more single-domain triggers based on the content of the events and apply any specified actions that alter the local data. As described below, each trigger engine 230 may also be called upon to evaluate a fragment or portion of a cross-domain trigger.

Coordinator 210 is a central entity that interacts with services in the various domains, through engines 230 for example, to coordinate execution of cross-domain triggers. The coordinator has read and write access to data of all services in all domains. Although the term ‘trigger’ is used herein, the term should be understood to encompass any type of computer-executable process or automation that performs desired data operations (e.g., to examine a set of data for one or more values) and that may perform one or more actions when the operations are successful. Also, services 222 should be understood to encompass any application, service, or product that features continuous or regular data operations, and may include chat and/or other communication applications, customer-support services, an ecommerce platform, information retrieval services, etc.

Coordinator 210 may comprise a single computer system or a cluster or other collection of cooperating computer systems that, individually and/or collectively, perform the functions described here. The coordinator may operate in a domain separate from domains 220.

Also shown in FIG. 2 is trigger configurator 250, which is a system, module, or service employed to configure cross-domain and/or single-domain triggers. In the illustrated environment, a user connects to trigger configurator 250, and the trigger configurator identifies the user to coordinator 210. Coordinator 210 may verify the user's authority or permissions, and then informs the trigger configurator of the set of trigger configuration rules and/or data domains/values available to the user. The coordinator will also supply the schema(s) needed by the user to construct a properly formed trigger.

The traffic configurator presents the user with a user interface that, based on the user's authorizations, is appropriately configured and offers access only to the trigger rules and conditions he or she is authorized to access. Thus, different users may configure triggers having the same or different scopes, depending on the services 222 they subscribe to, their home domain 220 (if they have one), their roles, etc. Coordinator 210 may maintain a registry of data schemas, or such a registry may reside elsewhere.

A hasty or naïve method of accessing data across domain boundaries may entail fetching data from different domains (i.e., the data needed to evaluate a given cross-domain trigger) or sharing one domain's data with another domain. However, this may expose the data or make it vulnerable to misuse. Instead, in embodiments described herein, controller 210 manages the routing of a trigger, or fragments/segments of the trigger, to the domains that maintain the data needed for evaluation of the trigger and/or execution of any actions specified by the trigger. Thus, in embodiments described herein, a common user interface is provided for constructing triggers across some or all data domains associated with an organization.

In some implementations, the system or environment of FIG. 2 is operated by an organization that hosts or provides services 222 to customers and/or other users. The services may illustratively include customer-support, messaging (e.g., between users and the organization, between users), ecommerce (e.g., sales of goods and/or services), guidance (e.g., user support for purchased goods/services, information retrieval), finance, education, etc. Different services may be offered in different embodiments.

In some embodiments, each domain stores triggers created within the domain, including cross-domain triggers, as well as fragments of triggers created within other domains (i.e., fragments that require access to the domain's data). Each cross-domain trigger has an identifier and its fragments have corresponding sequence numbers. When an event occurs among the domain's service(s), or an event of a particular type, the stored cross-domain trigger fragments are examined for any that have an initial sequence number (e.g., 1). These fragments are the initial fragments of the corresponding triggers and, because they are stored in this domain and therefore operate against the domain's data, are examined to determine if the event is the type of event that initiates the trigger and therefore requires the first fragment to be executed.

If the fragment fails (i.e., at least one data operation or condition of the fragment fails), no further processing is required. However, if the fragment passes, a central entity such as coordinator 210 of FIG. 2 is notified with the trigger's identifier and a data block that indicates that the initial fragment (fragment1) succeeded and that may optionally include values of the parameters accessed during execution/evaluation of the fragment.

The coordinator receives the notification, examines the trigger to identify the next fragment (e.g., fragment2), and calls the domain corresponding to the fragment. The coordinator may forward the data block received from the first fragment's domain. Each fragment's domain is thus invoked in turn, evaluates its portion of the cross-domain trigger's operations, and returns a response that indicates success or failure and that may include data values/contexts it employed.

If the cross-domain trigger was not decomposed into paths, when the coordinator encounters an OR operator within the trigger, it may call the next fragment's domain in each branch in parallel or may traverse each branch separately. Eventually, the coordinator determines whether any path through the trigger succeeds. If so, it can halt further processing of the trigger and proceed with execution of the trigger's associated actions.

For data security, privacy, and/or other reasons, data hosted in one domain generally relates closely to the service(s) operated within the domain, and processing or maintenance of one set of data (e.g., a customer-support ticket, a conversation within the messaging service, a sales transaction) using triggers may need only the data 224 local to the domain, in which case a single-domain trigger will accomplish the goal without complication. However, when a trigger is used to apply a more complex business rule that depends on data from different services, a cross-domain trigger is needed to securely access multiple domains' data.

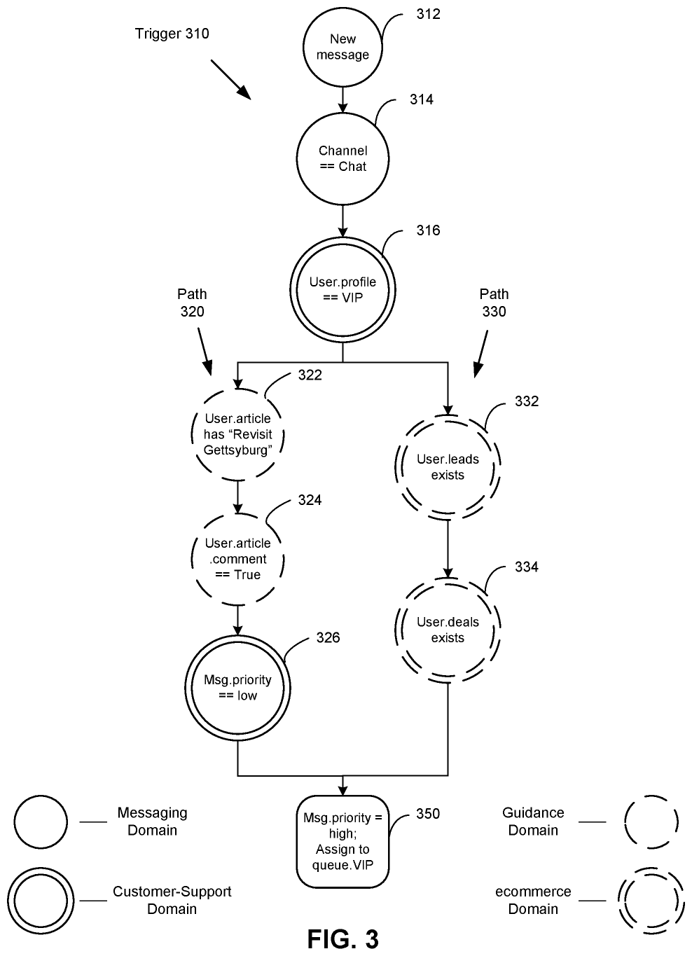

FIG. 3 depicts a cross-domain trigger according to some embodiments. In these embodiments, configurations of the nodes of the graph representing the trigger reflect the different domains invoked by the cross-domain trigger.

Trigger 310 comprises root node 312, which corresponds to receipt of a new message event in a messaging service/domain. Condition 314 involves a determination whether the message was received via a chat channel; as the shape of the condition 314 node indicates, this condition requires additional data from the messaging service's domain (which may be referred to as the messaging domain).

Then, condition 316, which corresponds to a customer-support service, examines whether the user that originated the new message is a VIP-level user. After condition 316, the trigger branches into two paths via an OR operation.

In path 320, conditions 322, 324 rely upon data in a guidance service's domain (or guidance domain) to determine whether the user that originated the message has viewed or obtained an article entitled “Revisiting the Gettysburg Address” and whether the user commented on the article, respectively. Condition 326 re-invokes the customer-support service to determine whether the priority of the new message is “low.”

Meanwhile, in path 330, conditions 332, 334 rely upon data in an ecommerce service domain (or ecommerce domain) to determine whether the user that originated the message exists in a set of sale leads data and whether the user is currently involved in a deal, respectively.

If conditions 312, 314, and 316 are True, and all conditions in either path 320 or path 330 are True, only then will the actions specified with end node 350 be applied or executed. Specifically, end node 350 causes the priority of the new message to be elevated to “high” and the message to be moved to a VIP queue for further handling. Cross-domain trigger 310 therefore requires access to data residing in at least four separate domains.

Upon creation and configuration of trigger 310, using trigger configurator 250 of FIG. 2, for example, it is submitted to coordinator 210, which includes program code for resolving or dividing cross-domain triggers into fragments based on the domains that contain the data needed to evaluate the trigger's conditions. It may be recalled that coordinator 210 maintains or has access to all data schemas; it also stores information regarding the parameters that reside in each domain of the operating environment.

In example trigger 310 of FIG. 3, the coordinator defines four separate trigger fragments-one each for the messaging, customer-support, guidance, and ecommerce domains. Because the trigger is initiated by receipt of a messaging event, the entire trigger may be stored in the messaging domain (e.g., in the corresponding engine 230 or data store 224). Also, however, the foreign fragments (i.e., for the customer-support, guidance, and ecommerce domains) will be distributed to engines 230 in their home domains.

Cross-domain trigger 310 and each of the four fragments of the trigger is assigned a unique identifier and/or sequence number. Also, the sequence of the fragments is recorded so that they can be evaluated in the appropriate order. For example, a first fragment (e.g., fragment1) may be defined to comprise conditions 312, 314, a second fragment (e.g., fragment2) may comprise conditions 316, 326, a third fragment (e.g., fragment3) may comprise conditions 322, 324, and a fourth fragment (e.g., fragment4) may comprise conditions 332, 334. In some implementations, fragment1 may be defined to include only condition 314, and condition 312 may be considered the root node that, while it initiates the trigger, is not treated as part of any fragment.

In this illustrative cross-domain trigger, the conditions of each fragment are adjacent and successive except for fragment2. To ensure fragment2's conditions are evaluated in the correct order (i.e., condition 316 before condition 326), subfragment identifiers may be assigned to one or more subsets of the fragment's operations. Thus, condition 316 may be identified as fragment2.subfragment1 and condition 326 may be identified as fragment2.subfragment2.

When cross-domain trigger 310 is activated (i.e., upon receipt of new message at the messaging service), and with reference to the system/environment of FIG. 2, the trigger engine 230 executing with or within the messaging service evaluates fragment1 (i.e., condition 314). If it evaluates to True, the engine or service calls coordinator 210 with identifiers of the remaining trigger fragments.

Coordinator 210 then calls the customer-support service/trigger engine associated with the fragment2 (fragment2.subfragment1) to cause evaluation of fragment2. The coordinator is notified of the result and, if it evaluates to True, calls the guide service/trigger engine to cause evaluation of fragment3. The coordinator is advised of the outcome and, if it evaluates to True, once again calls the customer-support service/trigger engine to invoke fragment2.subfragment2. Finally, the coordinator calls the ecommerce service/trigger engine to cause fragment4 to be evaluated. If either path through trigger 310 is satisfied, action 350 is executed by calling the necessary service(s) (e.g., customer-support).

In some alternative embodiments, instead of invoking the customer-support service/trigger engine for fragment2 twice (i.e., once for each subfragment), both subfragments may be evaluated in a single call, with coordinator 210 being advised of the outcomes of both evaluations.

Thus, although trigger fragments and data operations are performed in the order specified by the trigger in some embodiments, in other embodiments they may be executed out of order. For example, after a multi-path trigger is decomposed into individual paths in which all data operations are connected by AND operators, a fragment and its operations may be invoked or considered out of order. As one consequence, after a given data operation, trigger fragment, or trigger subfragment is evaluated and found to fail, some or all other paths that include the same data operation, fragment, or subfragment may be removed from consideration because it is known that they will fail.

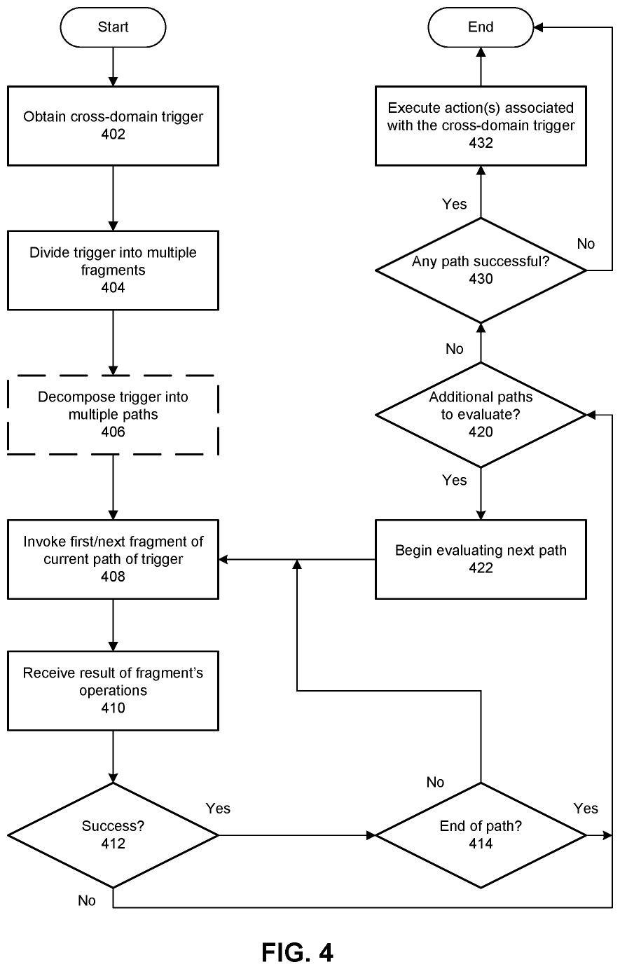

FIG. 4 is a flow chart illustrating a method of executing a trigger or other automated process across domain boundaries, according to some embodiments. In some implementations, one or more of the operations may be omitted, repeated, and/or performed in a different order. Accordingly, the specific arrangement of steps shown in FIG. 4 should not be construed as limiting the scope of the embodiments.

In these embodiments, the trigger is a cross-domain trigger that comprises a plurality of data operations involving data residing in multiple different domains. Data from one domain is not shared with any other domain; instead, each domain is called upon to execute or evaluate its share of the data operations. Some or all steps of this method may be performed by a coordinator entity that coordinates execution of the various data operations within their home domains.

In operation 402, the cross-domain trigger is obtained from a repository, a trigger configurator, or some other source. The trigger can be represented as a directed graph of the data comparisons, conditions, and/or other operations involving data within the different domains. The trigger may include a root or root node, which may correspond to an event, condition, or something else that initiates execution of the trigger. The trigger may also include an end or end node that may specify one or more actions or additional data operations to be performed if a path of the trigger is successfully traversed.

In operation 404, the cross-domain trigger is logically divided into multiple fragments, wherein each fragment corresponds to one of the multiple domains and comprises data operations that involve data residing in the corresponding domain. A given fragment may comprise contiguous and/or non-contiguous operations within the trigger, and may be divided into subfragments when, for example, the fragment's data operations include non-contiguous operations or operations located in different paths of the trigger.

In optional operation 406, the trigger may be decomposed into multiple paths if it includes one or more Boolean OR operators. In each resulting path, all data operations will be coupled with AND operators, and a given data operation may be included in multiple paths.

When the trigger is decomposed into multiple paths, each path may be traversed and its data operations executed, in the order (of both fragments and data operations) they are encountered in a directed graph representation of the cross-domain trigger. Results of the execution of a fragment or subfragment may be recorded, at least until the trigger has been fully processed, and particularly if the fragment or subfragment is part of multiple paths. This allows the system to avoid calling the corresponding domain multiple times to execute the same operations.

In some other embodiments, operations 404 and 406 may be reversed. In other words, the cross-domain trigger may first be decomposed into paths and then the paths may be divided into fragments.

In operation 408, a first fragment that includes the first data operation(s) of the trigger in a first path (or the only path) is invoked to have its data operations executed. This may involve calling a trigger engine or a service executing within the corresponding domain with an identifier of the fragment. When operation 408 is repeated for the same path or trigger, the next fragment is invoked.

In response to the call, in operation 410, the corresponding domain (e.g., its trigger engine or responsible service) executes the data operations of the currently fragment, in order, and returns a result to indicate whether they completed successfully.

In operation 412, the system determines whether the fragment's (or subfragment's) operations completed successfully (e.g., whether all conditions in the fragment evaluated to True). If so, the method advances to operation 414. Otherwise, because at least one operation of this fragment failed, the current path cannot be successfully completed; therefore, the method advances to operation 420.

In operation 414, if the end of the current path has been reached, the method advances to operation 420. Otherwise, it returns to operation 408 to invoke the next fragment to have its data operations executed or evaluated.

In operation 420, the system determines whether one or more paths remain to be evaluated (especially if no path has been successfully traversed). If so, the method proceeds to operation 422; otherwise, the method advances to operation 430.

In operation 422, evaluation of a next path commences. As indicated above, some or all results of already evaluated fragments may be retained to avoid re-invoking them. After operation 422, the method returns to operation 408 to invoke the first fragment of the new path.

In operation 430, the system determines whether any path through the cross-domain trigger was traversed successfully, meaning that all data operations of all fragments of at least one path completed successfully. If so, the method continues with operation 432. Otherwise, the method ends.

In some embodiments, processing of the cross-domain trigger may be terminated once a path is successfully traversed, meaning that all data operations of all fragments (and/or subfragments) in the path, between the root and the end of the trigger, completed successfully. In these embodiments, the method may proceed directly from operation 414 (when a successful path is identified), or some other operation, to operation 432.

In operation 432, the action(s) associated with the cross-domain trigger, which may be specified in an end node of the trigger, are executed. These actions may involve modifying data in any number of the domains of the operating environment, sending a communication to a user, an agent, or some other entity, or taking some other action.

In some embodiments, a cross-domain trigger's associated actions may require activity by multiple domains. In these embodiments, therefore, the actions may be decomposed into fragments, and then each fragment may be invoked in turn, similar to the manner in which the rest of the trigger was divided into fragments prior to executing them. After operation 432, the method ends.

By configuring privacy controls or settings as they desire, members of an online service, an ecommerce system, a social network, a professional network, or other user community that may use or interact with embodiments described herein can control or restrict the information collected from them, the information that is provided to them, their interactions with such information and with other members, and/or how such information is used. Implementation of an embodiment described herein is not intended to supersede or interfere with the members' privacy settings.

An environment in which one or more embodiments described above are executed may incorporate a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A method of executing data operations across multiple domains, the method comprising:
obtaining a trigger comprising ordered data operations involving data residing in multiple domains;
defining multiple fragments within the trigger, wherein each fragment corresponds to one domain and comprises data operations involving data residing in the corresponding domain;
for each of one or more paths through the trigger, executing each fragment's data operations, in order, until:
at least one data operation of at least one fragment fails; or
all data operations of all fragments in at least one path succeed; and
when all data operations of all fragments in at least one path succeed, executing one or more actions associated with the trigger.

2. The method of claim 1, wherein the trigger comprises:
a root node that specifies an event that activates the trigger; and
an end node that specifies the one or more actions.

3. The method of claim 1, wherein each path comprises the root node, the end node, and one or more data operations of one or more of the multiple fragments.

4. The method of claim 1, wherein:
each data operation includes an expression comprising:
a parameter;
a set of target values; and
an operator specifying a relationship between a current value of the parameter and the set of target values; and
execution of the data operation is successful when the relationship is true.

5. The method of claim 1, wherein said defining comprises:
for each data operation of the trigger, identifying a domain in which data required for the data operation resides; and
for each domain in which data required for at least one data operation of the trigger resides, grouping into a corresponding fragment all data operations of the trigger that involve data residing in the domain.

6. The method of claim 1, further comprising:
distributing the multiple fragments to their corresponding domains.

7. The method of claim 1, wherein the data operations of the trigger are coupled via Boolean operators and the method further comprises:
when the trigger includes at least one OR operator, decomposing the trigger into a plurality of paths.

8. The method of claim 7, further comprising, when different data operations of a first fragment are included in different paths of the trigger, defining subfragments of the first fragment to comprise, for each different path, the data operations of the first fragment included in the path.

9. The method of claim 1, wherein executing each fragment's data operations comprises:
calling a trigger engine operating in the corresponding domain with an identifier of the fragment; and
receiving a response indicating whether the data operations completed successfully.

10. The method of claim 1, wherein obtaining the trigger comprises:
identifying a user initiating creation of a new trigger;
determining the user's data access permissions;
presenting the user with an interface for creating the new trigger, wherein all users that initiate creation of new triggers receive the same interface, customized according to each user's access permissions; and
receiving the new trigger as the trigger.

11. The method of claim 1, further comprising:
within each of the multiple domains, hosting a different set of services;
wherein the data residing in each domain comprises data associated with operation of the domain's set of services.

12. A system for executing data operations across multiple domains, comprising:
multiple logically distinct domains;
a coordinator computer system comprising one or more processors and memory storing instructions that, when executed by the one or more processors, cause the coordinator computer system to:
obtain a trigger comprising ordered data operations involving data residing in the multiple domains;
define multiple fragments within the trigger, wherein each fragment corresponds to one domain and comprises data operations involving data 10 residing in the corresponding domain;
for each of one or more paths through the trigger, execute each fragment's data operations, in order, until:
at least one data operation of at least one fragment fails; or
all data operations of all fragments in at least one path succeed; and
when all data operations of all fragments in at least one path succeed, execute one or more actions associated with the trigger.

13. The system of claim 12, further comprising:
a configurator computer system for facilitating creation of triggers;
wherein obtaining the trigger includes receiving the trigger from the configurator computer system.

14. The system of claim 12, further comprising:
a configurator computer system for facilitating creation of triggers and comprising at least one processor and memory storing instructions that, when executed by the at least one processor, cause the configurator computer system to:
identify to the coordinator computer system a user initiating creation of a new trigger;
receive from the coordinator computer system the user's data access permissions;
present the user with an interface for creating the new trigger, customized according to the user's access permissions; and
transmit the new trigger to the coordinator computer system;
wherein the new trigger is the trigger.

15. The system of claim 12, further comprising:
within each of the multiple domains, a unique set of services accessed by users;
wherein data residing in each of the multiple domains includes data associated with the domain's unique set of services.

16. The system of claim 12, wherein the trigger comprises:
a root node that specifies an event that activates the trigger; and
an end node that specifies the one or more actions.

17. The system of claim 16, wherein each path comprises the root node, the end node, and one or more data operations of one or more of the multiple fragments.

18. The system of claim 12, wherein:
each data operation includes an expression comprising:
a parameter;
a set of target values; and
an operator specifying a relationship between a current value of the parameter and the set of target values; and
execution of the data operation is successful when the relationship is true.

19. The system of claim 12, wherein said defining comprises:
for each data operation of the trigger, identifying a domain in which data required for the data operation resides; and
for each domain in which data required for at least one data operation of the trigger resides, grouping into a corresponding fragment all data operations of the trigger that involve data residing in the domain.

20. The system of claim 12, further comprising:
distributing the multiple fragments to their corresponding domains.

21. The system of claim 12, wherein the data operations of the trigger are coupled via Boolean operators and the method further comprises:
when the trigger includes at least one OR operator, decomposing the trigger into a plurality of paths.

22. The system of claim 21, further comprising, when different data operations of a first fragment are included in different paths of the trigger, defining subfragments of the first fragment to comprise, for each different path, the data operations of the first fragment included in the path.

23. The system of claim 12, further comprising:
within each domain, a trigger engine for executing data operations;
wherein executing each fragment's data operations comprises:
calling a trigger engine operating in the corresponding domain with an identifier of the fragment; and
receiving a response indicating whether the data operations completed successfully.
